(19) United States
(12) Patent Application Publication
(10) Pub. No.: US 2008/0316363 A1
(43) Pub. Date: Dec. 25, 2008

(54) System and method for estimating noises in a video frame

(75) Inventor: Yuan-Chih Peng, Taipei City (TW)

Correspondence Address: BACON & THOMAS, PLLC, 625 SLATERS LANE, FOURTH FLOOR, ALEXANDRIA, VA, 22314-1176, US

(73) Assignee: Sunplus Technology Co., Ltd., Hsinchu (TW)

(21) Appl. No.: 12/149,305

(22) Filed: Apr. 30, 2008

(30) Foreign Application Priority Data
Jun. 20, 2007 (TW) 096122148

(51) Int. Cl. H04N 5/00

(52) U.S. Cl. 348/607; 348/E05.001

(57) ABSTRACT

A system and method for estimating noises in a frame is disclosed. A storage device is provided to store a previous frame prior to the frame. Multiple window noise estimators are provided to estimate noise between sub-regions of the frame and corresponding sub-regions of the previous frame for producing a noise estimation index and an adjusted noise estimation index for each sub-region. A comparator selects the minimum one among the adjusted noise estimation indexes and produces a corresponding window index. When the minimum adjusted noise estimation index is smaller than a threshold, a global motion detector outputs the noise index corresponding to the minimum adjusted noise estimation index for use as a noise estimation of the frame.

### BACKGROUND OF THE INVENTION

1. Field of the Invention

The present invention relates to a technical field of processing images and, more particularly, to a system and method for estimating noises in a video frame.

2. Description of Related Art

Television (TV) signals easily suffer the interference in transmission to thus contain noises. To reduce the interference of the noises, a noise reduction is typically provided in a display section. However, the noise reduction in either spatial or temporal domain possibly produces various side effects. Generally, the noise reduction is preferred to first analyze the noise levels of input video frames and then take various noise reduction processes according to the noise levels analyzed.

U.S. Pat. No. 5,844,627 granted to May, et al. discloses a “Structure and method for reducing spatial noise” which first analyzes the spatial frequency components and then suppresses the possible bands with noises. However, the method for spatial noise reduction cannot completely separate the noises from the video components in the spatial domain, and thus the side effect of blurs easily presents in the video. U.S. Pat. No. 6,259,489 granted to Flannaghan, et al. for a “Video noise reducer” teaches a method for temporal noise reduction, with which the pixels of a still frame on a same spatial position at different time are taken a mean operation along an axis of time in case that the noises are uncorrelated in the axis of time and have a mean of zero. Accordingly, the reduced noise variance and the video with a lower noise level are achieved. However, the temporal noise reduction has to operate with detection of motion object occurrence in the video to thereby avoid the occurrence of inappropriately averaging the samples at different spatial positions and thus producing a motion blur or residual, even obtaining the reduced noises without losing the spatial definition on the still frame.

Generally, a viewer shows high tolerance in the side effects caused by the noise reduction when the noise is at a high level, and the view relatively reduces the tolerance caused by the noise reduction to a lower degree when the noise is at a low level. Since the unacceptable defects are produced when a strong noise reduction and filtering method is applied to a low-noise video signal or the insufficient noise reduction on a high-noise video signal presents when a weak noise reduction and filtering method is applied, an accurate noise level measurement is required for an input video signal. Namely, appropriate noise reduction and filtering strength is required for a good noise processing.

In order to accurately measure the noise level in the input video signal, U.S. Pat. No. 5,657,401 granted to Choi for a “Method for driving a matrix liquid crystal display panel with reduced cross-talk and improved brightness ratio” teaches to compare the sum of temporal absolute differences with a set of thresholds. When the sum locates in the upper and lower boundaries of the set, an accumulator is increased by one, and subsequently it is determined whether a total number of pixels in a predetermined interval is equal to an expected value. When the total number of pixels in the predetermined interval does not equal to the expected value, the set of thresholds is adjusted to thereby respond the noise level in the video signal. However, a frame contains the different proportions of motion areas, and accordingly the expected value cannot be predetermined easily and the noise level measurement can be easily affected by the number of pixels corresponding to the motion areas in the frame.

To overcome the aforementioned problem, U.S. Pat. No. 6,307,888 granted to Le Clerc for a “Method for estimating the noise level in a video sequence” teaches to use the measured motion estimation information to divide a signal into still and motion blocks. The still and the motion blocks are operated (such as calculating the sum of temporal absolute differences) with corresponding positions (still) or corresponding motion compensation blocks (motion) to find the noise estimates of the still and the motion blocks respectively, and subsequently the noise estimates of the still and the motion blocks are mixed to thereby obtain a final noise estimate. Such a method requires an accurate motion estimation to thus measure the accurate noise levels in the motion blocks. However, a typical TV display system does not contain a motion estimation and compensation operation.

US Patent Application Publication No. 2006/0221252 entitled “Reliability estimation of temporal noise estimation” teaches to convert a distribution of the temporal local difference into a characteristics value and compares the characteristics value to a threshold corresponding to an ideal distribution to accordingly determine to remain or discard the noise level of the current frame. The different motion degrees generally affect the distribution of the temporal local difference. However, the number of motion pixels present in the video signal is different, and the difference of motion time produced in the video signal is different. Accordingly, the distribution of the temporal local difference is gradually changed with the different motions, which increases the difficulty of finally determining to remain or discard the threshold.

Therefore, it is desirable to provide an improved system and method to mitigate and/or obviate the aforementioned problems.

### SUMMARY OF THE INVENTION

An object of the present invention is to provide a system and method for estimating noises in a video frame, which can exclude the noise estimates with overlarge differences to thereby prevent the noise overestimation due to the affection of a global motion in a video frame.

Another object of the present invention is to provide a system and method for estimating noises in a video frame, which can increase the differentiability of noise estimates and reduce the sensitivity of motion threshold and subframe range settings, when the motion occurs in the video frame.

To achieve a feature of the invention, a system for estimating noises in a video frame is provided, which performs a noise estimation on a frame. The system includes a storage device, multiple window noise estimators, a comparator and a global motion detector. The storage device stores a previous frame immediately prior to the frame. The window noise estimators are connected to the storage device in order to estimate noise between sub-regions of the frame and corresponding sub-regions of the previous frame for producing a noise estimation index and an adjusted noise estimation index for each sub-region and corresponding sub-region. The comparator is connected to the window noise estimators in order to select a minimum one among the adjusted noise estimation indexes and produce a window index which indicates a window corresponding to the minimum adjusted noise estimation index. The global motion detector is connected to the window noise estimators and the comparator in order to output a noise estimation index corresponding to the minimum adjusted noise estimation index for use as a noise estimate for the frame when the minimum adjusted noise estimation index is smaller than a threshold.

To achieve another feature of the invention, a method for estimating noises in a video frame is provided, which performs a noise estimation on a frame. The method includes: a storing step, which stores a previous frame immediately prior to the frame; multiple window noise estimating steps, each estimating the noise between a sub-region of the frame and a corresponding sub-region of the previous frame to produce a noise estimation index and an adjusted noise estimation index; a comparing step, which selects a minimum one among the adjusted noise estimation indexes, and produces a window index which indicates a window corresponding to the minimum adjusted noise estimation index; and a global motion detecting step, which outputs a noise estimation index corresponding to the minimum adjusted noise estimation index for use as a noise estimate for the frame when the minimum estimation adjustment index is smaller than a threshold, and otherwise outputs a flag indicating that the noise estimate for the frame is affected by a global motion.

Other objects, advantages, and novel features of the invention will become more apparent from the following detailed description when taken in conjunction with the accompanying drawings.

### BRIEF DESCRIPTION OF THE DRAWINGS

FIG. 1 is a block diagram of a system for estimating noises in a video frame according to the invention;

FIG. 2 is a schematic diagram of sub-regions and corresponding sub-regions in a frame F[n] and a previous frame F[n−1] according to the invention;

FIG. 3 is a block diagram of a window noise estimator according to the invention; and

FIG. 4 is a block diagram of a distribution calculator according to the invention.

### DETAILED DESCRIPTION OF THE PREFERRED EMBODIMENT

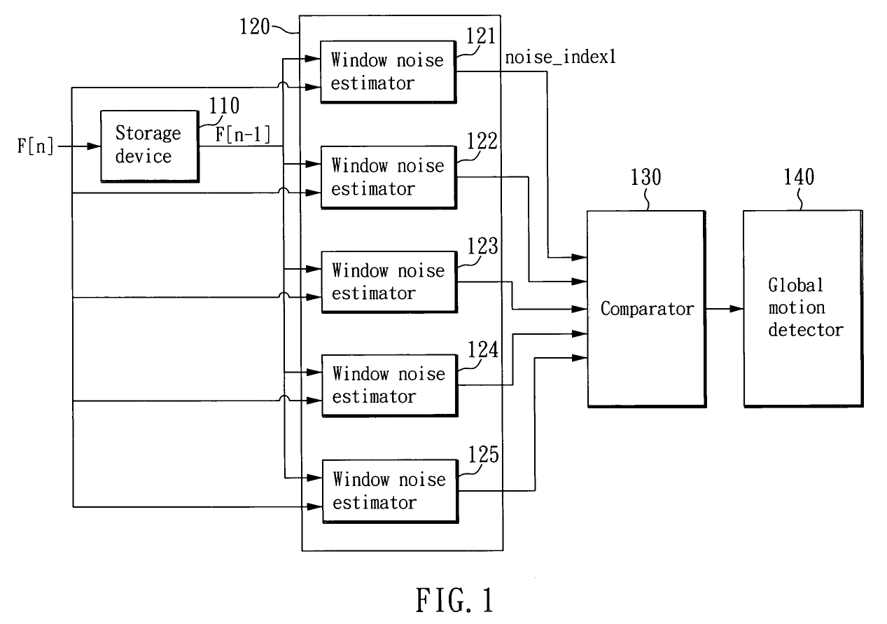

FIG. 1 is a block diagram of a system for estimating noises in a video frame according to the invention. The system performs a noise estimation on a frame F[n] and includes a storage device 110, multiple window noise estimator 120, a comparator 130 and a global motion detector 140. The storage device stores a previous frame F[n−1] immediately prior to the frame F[n].

The multiple window noise estimators 120 are connected to the storage device 110 in order to estimate noises between the sub-regions of a frame F[n] and the corresponding sub-regions of the previous frame F[n−1] for producing a noise estimation index noise_index and an adjusted noise estimation index adj_noise_index for each sub-region and corresponding sub-region.

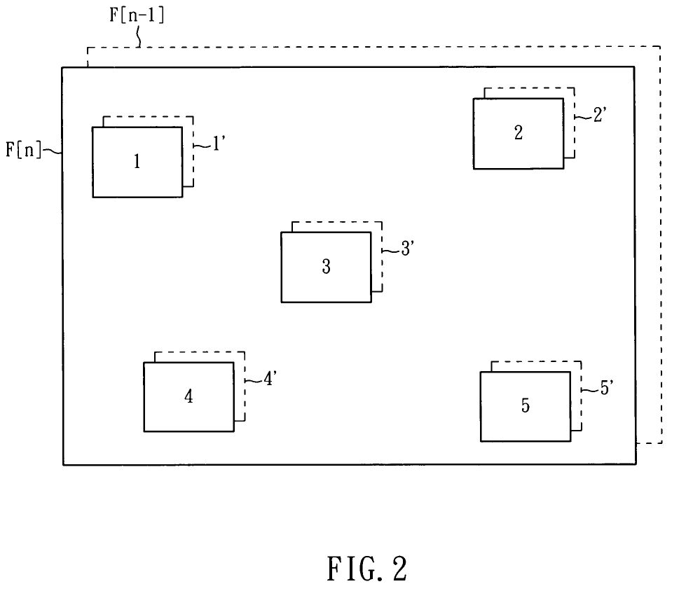

FIG. 2 is a schematic diagram of the sub-regions and corresponding sub-regions in the frame F[n] and the previous frame F[n−1] according to the invention. As shown in FIGS. 1 and 2, a first window noise estimator 121 corresponds to the sub-region 1 of the frame F[n] and the corresponding sub-region 1′ of the previous frame F[n−1], a second window noise estimator 122 corresponds to the sub-region 2 of the frame F[n] and corresponding sub-region 2′ of the previous frame F[n−1], and soon. In this case, five window noise estimators 121-125 are only for exemplary description, not for limit, and any number of window noise estimators can be used, if desired.

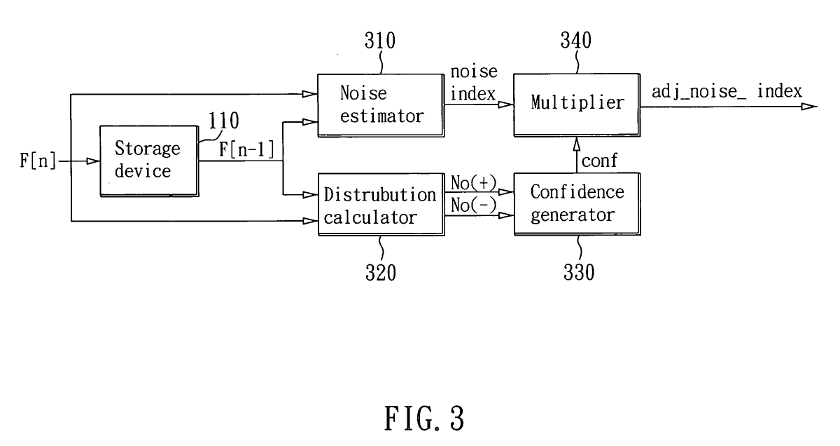

FIG. 3 is a block diagram of a window noise estimator according to the invention. As shown in FIG. 3, the window noise estimator includes a noise estimator 310, a distribution calculator 320, a confidence generator 330 and a multiplier 340.

The noise estimator 310 is connected to the storage device 110 in order to estimate noise between the sub-regions of a frame F[n] and the corresponding sub-region of the previous frame F[n−1] for producing a noise estimation index noise_index. The noise estimation index can be expressed as:

$${\sum }_{i , j} \vert {P}_{N} ( i , j ) - {P}_{N - 1} ( i , j ) \vert ,$$

where i, j are pixel regions of the sub-region and the corresponding sub-region covered by the window noise estimator, P_{N}(i,j) indicates a pixel of the frame F[n] that locates in the sub-region covered by the window noise estimator, and P_{N-1}(i, j) indicates a pixel of the previous frame F[n−1] that locates in the corresponding sub-region covered by the window noise estimator. For the first window noise estimator 121, i, j are pixel regions of the sub-region 1 and corresponding sub-region 1′ as shown in FIG. 2, P_{N}(i, j) indicates a pixel of the frame F[n] that locates in the sub-region 1, and P_{N-1}(i, j) indicates a pixel of the previous frame F[n−1] that locates in the corresponding sub-region 1′. Similarly, the sub-regions and corresponding sub-regions for the estimators 122-125 can be obtained accordingly.

The distribution calculator 320 is connected to the noise estimator 310 and the storage device 110 in order to calculate a distribution of positive and negative signs of pixel differences in the sub-regions of the frame F[n] and the corresponding sub-regions of the previous frame F[n−1] that are covered by the window noise estimator to accordingly output a positive sign number No(+) and a negative sign number No(−).

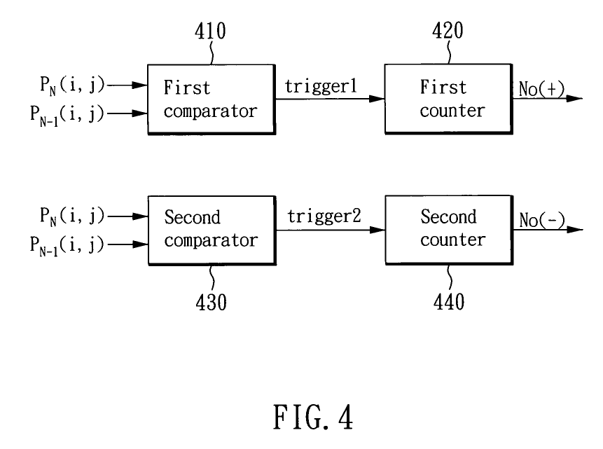

FIG. 4 is a block diagram of the distribution calculator 320 according to the invention. The distribution calculator 320 includes a first comparator 410, a first counter 420, a second comparator 430 and a second counter 440.

The first comparator 410 has a first input terminal to receive a pixel P_{N}(i, j) and a second input terminal to receive a pixel P_{N-1}(i, j). When the pixel P_{N}(i, j) is greater than the pixel P_{N-1}(i, j), a first trigger signal trigger1 is produced. The first counter 420 is connected to the first comparator 410 in order to count the positive sign number No(+) according to the first trigger signal trigger1.

The second comparator 430 has a first input terminal to receive the pixel P_{N}(i, j) and a second input terminal to receive the pixel P_{N-1}(i, j). When the pixel P_{N}(i, j) is smaller than the pixel P_{N-1}(i, j), a second trigger signal trigger2 is produced. The second counter 440 is connected to the second comparator 430 in order to count the negative sign number No(−) according to the second trigger signal trigger2.

The confidence generator 330 is connected to the distribution calculator 320 in order to produce a confidence value conf according to the positive sign number NO(+) and the negative sign number No(−). The confidence value conf can be expressed as:

1+|No(+)−No(−)|/total_no,

where No(+) indicates the positive sign number, No(−) indicates the negative sign number, and total_no indicates a total number of pixels of the sub-region covered by the window noise estimator. For example, for the first window noise estimator 121, total_no indicates a total number of pixels of the sub-region 1.

The multiplier 340 is connected to the confidence generator 330 and the noise estimator 310, and has a first input terminal to receive the noise estimation index noise_index and a second input terminal to receive the confidence value conf to thereby multiply the index noise_index by the confidence value conf and produce the adjusted noise estimation index adj_noise_index.

Referring back to FIG. 1, the comparator 130 is connected to the window noise estimators 120 in order to select a minimum one min_adj_noise_index among the adjusted noise estimation indexes adj_noise_index1˜adj_noise_index5, and output a window index window_index which indicates a window corresponding to the minimum adjusted noise estimation index min_adj_noise_index.

The global motion detector 140 is connected to the multiple window noise estimators 120 and the comparator 130 in order to output a noise estimation index noise_index corresponding to the minimum adjusted noise estimation index min_adj_noise_index when the minimum adjusted noise estimation index min_adj_noise_index is smaller than a threshold Th. For example, if the index adj_noise_index1 is the minimum one, the comparator 130 output the min_adj_noise_index as the adjusted noise estimation index. In this case, the global motion detector 140 outputs the noise estimation index noise_index1 as the noise estimate for the frame. When the minimum adjusted noise estimation index min_adj_noise_index is greater than or equal to the threshold Th, a flag is output to indicate that the noise estimate for the frame is affected by a global motion.

When the confidence value conf is one, it indicates that the positive sign number No(+) is equal to the negative sign number No(−). When the sub-region 2 corresponding to the second window noise estimator 122 presents a motion, the positive sign number No(+) is greater or smaller than the negative sign number No(−). In this case, the confidence value conf is greater than one, and the adjusted noise estimation index adj_noise_index2 corresponding to the second window noise estimator 122 increases. Accordingly, the probability of selecting the index adj_noise_index2 corresponding to the second window noise estimator 122 as an output by the comparator 130 is reduced, so that selecting the sub-region 2 can be prevented to further increase the accuracy of the noise estimation.

The invention selects multiple sub-regions of a frame, calculates a temporal difference for each sub-region, and analyzes a distribution of the temporal differences to thereby produce a confidence value to indicate the level of a motion affection. The probability that the differences are caused by the noises is increased as the confidence value increases. Namely, the probability that the differences are caused by the motion is increased as the confidence value decreased. The confidence indexes of each sub-region can be used as weights and added respectively to the corresponding noise estimates for comparison to thereby find a sub-region with the minimum noise estimate after weighting. Thus, the noise estimate before weighting for the sub-region is regarded as the noise estimate for the frame.

The invention divides the frame into the sub-regions and calculates a noise estimate for each sub-region. The noise estimate typically contains noise-based and motion-based components. For a same signal, the smaller the noise estimate for the sub-region is, the higher the noise level is. Such a statistic, selecting the size of sub-regions is important. Generally, when the size of sub-regions is small, the motion probability in a statistical operation is reduced. However, when the size of sub-regions is too small, the noise estimates for the sub-regions become localized and cannot respond the noise level for the entire frame. In addition, the noise estimation needs to compare the result obtained from each sub-region with a motion threshold to thereby exclude the overlarge noise estimates and prevent the noise overestimation due to the affection of a possible global motion (such as a lens motion). For a small sub-region, calculating the difference for the sub-region is affected least by the motion, but the variance of the noise level estimation is higher due to the fewer sampling points.

As compared to the prior art that only uses a sub-region with the smallest variance to find an initial noise estimate as a global noise estimate for a frame, the invention further analyzes the possibilities of motion occurrence and uses the possibilities to add different weights to the initial noise estimates. Accordingly, the differentiability of the noise estimates is increased in case that a motion likely occurs, and the sensitivity of motion threshold and sub-region settings is reduced.

Although the present invention has been explained in relation to its preferred embodiment, it is to be understood that many other possible modifications and variations can be made without departing from the spirit and scope of the invention as hereinafter claimed.

What is claimed is:

1. A system for estimating noises in a video frame, which performs a noise estimation on a frame, the system comprising:
a storage device, which stores a previous frame prior to the frame;
multiple window noise estimators, connected to the storage device in order to estimate noise between sub-regions of the frame and corresponding sub-regions of the previous frame for producing a noise estimation index and an adjusted noise estimation index for each sub-region and corresponding sub-region;
a comparator, connected to the multiple window noise estimators in order to select a minimum one among the adjusted noise estimation indexes and produce a window index which indicates a window corresponding to the minimum adjusted noise estimation index; and
a global motion detector device, connected to the multiple window noise estimators and the comparator in order to output the noise estimation index corresponding to the minimum adjusted noise estimation index for use as a noise estimate for the frame when the minimum adjusted noise estimation index is smaller than a threshold.

2. The system as claimed in claim 1, wherein a flag indicating the noise estimate for the frame is affected by a global motion is output when the minimum adjusted noise estimation index is greater than or equal to the threshold.

3. The system as claimed in claim 1, wherein each window noise estimator comprises:
a noise estimator, connected to the storage device in order to estimate the noise between the sub-region of the frame and the corresponding sub-region of the previous frame to produce the noise estimation index.

4. The system as claimed in claim 3, wherein the noise estimation index is expressed as:
$${\sum }_{i , j} \vert {P}_{N} ( i , j ) - {P}_{N - 1} ( i , j ) \vert ,$$
where i, j are pixel regions of the sub-region and the corresponding sub-region covered by the window noise estimator, P_{N}(i, j) indicates a pixel of the frame that locates in the sub-region covered by the window noise estimator, and P_{N-1}(i, j) indicates a pixel of the previous frame that locates in the corresponding sub-region covered by the window noise estimator.

5. The system as claimed in claim 4, wherein the window noise estimator further comprises:
a distribution calculator, connected to the noise estimator in order to calculate a distribution of positive and negative signs of pixel differences in the sub-region of the frame and the corresponding sub-region of the previous frame that are covered by the window noise estimator to output a positive sign number and a negative sign number.

6. The system as claimed in claim 5, wherein the distribution calculator comprises:
a first comparator, having a first input terminal to receive the pixel P_{N}(i, j) and a second input terminal to receive the pixel P_{N-1}(i, j) and producing a first trigger signal when the pixel P_{N}(i, j) is greater than the pixel P_{N-1}(i, j); and
a first counter, which is connected to the first comparator in order to count the positive sign number according to the first trigger signal.

7. The system as claimed in claim 6, wherein the distribution calculator further comprises:
a second comparator, having a first input terminal to receive the pixel P_{N}(i, j) and a second input terminal to receive the pixel P_{N-1}(i, j) and producing a second trigger signal when the pixel P_{N}(i, j) is smaller than the pixel P_{N-1}(i, j); and
a second counter, connected to the second comparator in order to count the negative sign number according to the second trigger signal.

8. The system as claimed in claim 7, wherein the window noise estimator further comprises:
a confidence generator, connected to the distribution calculator to produce a confidence value according to the positive sign number and the negative sign number.

9. The system as claimed in claim 8, wherein the confidence value is expressed as:
1+|No(+)−No(−)|/total_no,
where No(+) indicates the positive sign number, No(−) indicates the negative sign number, and total_no indicates a total number of pixels of the sub-region covered by the window noise estimator.

10. The system as claimed in claim 9, wherein the window noise estimator further comprises:
a multiplier, connected to the confidence generator and the noise estimator, and having a first input terminal to receive the noise estimation index and a second input terminal to receive the confidence value to multiply the noise estimation index by the confidence value and produce the adjusted noise estimation index.

11. A method for estimating noises in a video frame, which performs a noise estimation on a frame, the method comprising:
a storing step, storing a previous frame prior to the frame;
multiple window noise estimating steps, each estimating noise between a sub-region of the frame and a corresponding sub-region of the previous frame to produce a noise estimation index and an adjusted noise estimation index;
a comparing step, selecting a minimum one among the adjusted noise estimation indexes, and producing a window index which indicates a window corresponding to the minimum adjusted noise estimation index; and
a global motion detecting step, outputting a noise estimation index corresponding to the minimum adjusted noise estimation index for use as a noise estimate for the frame when the minimum estimation adjustment index is smaller than a threshold, and otherwise outputting a flag indicating the noise estimate for the frame is affected by a global motion.

12. The method as claimed in claim 11, wherein each window noise estimating step comprises:
a noise estimating step, estimating the noise between the sub-region of the frame and the corresponding sub-region of the previous frame to produce the noise estimation index;
a distribution calculating step, calculating a distribution of positive and negative signs of pixel differences in the sub-region of the frame and the corresponding sub-region of the previous frame that are covered by the window noise estimator to accordingly output a positive sign number and a negative sign number;
a confidence generating step, producing a confidence value according to the positive sign number and the negative sign number; and
a multiplication step, multiplying the noise estimation index by the confidence value and producing the adjusted noise estimation index.

13. The method as claimed in claim 12, wherein the noise estimation index (SAD) is expressed as:
$${\sum }_{i , j} \vert {P}_{N} ( i , j ) - {P}_{N - 1} ( i , j ) \vert ,$$
where i, j are pixel regions of the sub-region and the corresponding sub-region covered by the window noise estimator, P_{N}(i, j) indicates a pixel of the frame that locates in the sub-region covered by the window noise estimator, and P_{N-1}(i, j) indicates a pixel of the previous frame that locates in the corresponding sub-region covered by the window noise estimator.

14. The method as claimed in claim 13, wherein the distribution calculating step comprises:
a first comparing step, producing a first trigger signal when the pixel P_{N}(i, j) is greater than the pixel P_{N-1}(i, j); and
a first counting step, counting the positive sign number according to the first trigger signal.

15. The method as claimed in claim 14, wherein the distribution calculating step further comprises:
a second comparing step, producing a second trigger signal when the pixel P_{N}(i, j) is smaller than the pixel P_{N-1}(i, j); and
a second counting step, counting the negative sign number according to the second trigger signal.

16. The method as claimed in claim 15, wherein the confidence value is expressed as:
1+|No(+)−No(−)|/total_no,
where No(+) indicates the positive sign number, No(−) indicates the negative sign number, and total_no indicates a total number of pixels of the sub-region covered by the window noise estimator.
